(19) United States
(12) Patent Application Publication
(10) Pub. No.: US 2013/0339192 A1
(43) Pub. Date: Dec. 19, 2013

(54) METHOD AND SYSTEM FOR LONGTERM INVENTORY DISTRIBUTION FINANCING AND MANAGEMENT

(71) Applicant: Flextronics AP, LLC, San Jose, CA (US)

(72) Inventors: Christopher P. Ricci, Saratoga, CA (US); Andrew R. Straus, Santa Clara, CA (US)

(21) Appl. No.: 13/918,038

(22) Filed: Jun. 14, 2013

Related U.S. Application Data
(60) Provisional application No. 61/659,616, filed on Jun. 14, 2012.
(60) Provisional application No. 61/665,119, filed on Jun. 27, 2012.
(60) Provisional application No. 61/715,705, filed on Oct. 18, 2012.

(51) Int. Cl. G06Q 30/06

(52) U.S. Cl. CPC G06Q 30/0635
USPC 705/26.81

(57) ABSTRACT

The present disclosure is directed to various computational systems for structuring, financing, and/or managing inventory transfers from an original supplier to a servicing entity.

### CROSS REFERENCE TO RELATED APPLICATION

The present application claims the benefits of U.S. Provisional Application Ser. Nos. 61/659,616, filed Jun. 14, 2012, 61/665,119, filed Jun. 27, 2012, and 61/715,705, filed Oct. 18, 2012, having the same title and each of which is incorporated herein by this reference in its entirety.

### FIELD

The disclosure relates generally to automated systems for inventory management and particularly to automated systems for inventory distribution financing and management.

### BACKGROUND

The global economy has created many challenges for businesses. Inventory or stock is frequently purchased in one country and shipped for sale and/or use in another country. Depending on the nature of the inventory or stock, the inventory can take prolonged periods in transit from the seller to the purchaser. When the purchaser takes ownership at the seller's location, the purchaser is required to reflect the inventory on its books and balance sheets, even though it does not have possession. When the purchaser takes ownership at the purchaser's location, the purchaser is responsible for shipping, insurance and/or loss or damage to the inventory, thereby requiring the purchaser to demand a significantly higher price for the inventory than in when ownership is transferred prior to shipment.

In other industries, particularly electronics-related industries, inventory item(s), particularly spare part inventory for previously sold systems, is/are required to be maintained over a life of a system. A problem arises from the need not only to store and maintain inventory (and tie up working capital) where there is low inventory turnover but also to reflect the stored inventory under generally accepted accounting principles (“GAAP”) on the manufacturer's books and balance sheets. This is particularly a problem for publicly held companies that may need to reflect the book cost of inventory, sometimes for decades, on internal and published accounting records (e.g., balance sheets) and regulatory filings. Hundreds of companies worldwide are carrying inventory, having such stringent inventory requirements, on books and balance sheets, thereby increasing not only the apparent working capital position of the company but also the manufacturing cost and price of the original products and/or replacement parts.

### SUMMARY

These and other needs are addressed by the various aspects, embodiments, and/or configurations of the present disclosure. The present disclosure is directed to a partially or fully automated materials management warehousing and distribution solution that is particularly applicable to inventory that is transported long distances and/or that has a relatively low rate of turnover.

In a typical application, one or more servers (e.g., service provider, servicing entity and original supplier servers) receive a customer purchase order for one or more items in inventory and one or more databases associated with an original supplier, service provider, and servicing entity include data indicating that the one or more inventory items was supplied by the original supplier, is in the possession of the service provider, and is owned by the servicing entity. Commonly, the servicing entity purchased the inventory from the original supplier.

The present disclosure can include a system, method, and/or computer readable medium, comprising microprocessor executable logic operable to:

send, by the one or more servers, (a) a product shipment notification indicating that the inventory items have been shipped by the service provider to the customer and/or (b) an invoice to a server of the customer for the re inventory items; and

perform one or more of the following steps:
(A) send, by the service provider server and/or the servicing entity server, an inventory report to a server associated with the original supplier, the inventory report comprising information regarding on-hand inventory in the possession of the service provider; and
(B) send, by the service provider server and/or servicing entity server, the inventory report to a server associated with a financing entity, the financing entity having financed at least part of a purchase price of the inventory.

In one application, the system can include a microprocessor executable service provider inventory management module and a service provider server including and/or in communication with the service provider inventory management module, and a service provider database comprising data indicating that the one or more inventory items was supplied by an original supplier, is currently in the possession of the service provider, and is currently owned by a servicing entity. The service provider can receive a customer purchase order for the items in inventory. A system, method, and/or tangible and non-transient computer readable medium can include microprocessor executable instructions for the inventory management module that, when executed by a microprocessor, perform steps/operations comprising:

send (a) a product shipment notification indicating that the one or more inventory items have been shipped by the service provider to the customer and/or (b) an invoice to a server of the customer for the one or more inventory items; and

at least one of the following:

(A) send, by the service provider server, an inventory report to an original supplier server of the original supplier, the inventory report comprising information regarding on-hand inventory in the possession of the service provider; and

(B) send, by the service provider server, the inventory report to a server associated with a financing entity, the financing entity having financed at least part of a purchase price of the inventory when purchased by the servicing entity from the original supplier.

The inventory items commonly have previously been sold by the original supplier to the servicing entity and relocated to a warehouse of the service provider.

The customer purchase order can be received by any of the original supplier server, servicing entity server, and service provider server.

In one application, the original supplier server receives the customer purchase order and sends to the service provider server a request to ship the one or more inventory items to the customer. The invoice for the inventory items can be sent, by the original supplier server to the customer server. The customer can pay the original supplier for the inventory items.

The one or more servers can send a servicing entity invoice to the original supplier server. The original supplier can, in turn, pay the servicing entity for the inventory items.

The original supplier can determine, based on the inventory report, whether one or more customer inventory requirements are satisfied and, when the one or more customer inventory requirements are unsatisfied or are in danger of being unsatisfied, cause the servicing entity to send, via the servicing entity server, a purchase order to the original supplier server for more inventory items.

The financing entity can determine a loan payment based on the inventory report.

One or more of the following can be true: the service provider does not control the servicing entity, the servicing entity does not control the service provider, and the servicing entity and service provider are not under common control. When the service provider does not control the servicing entity, the inventory items can be located physically in a warehouse owned by the service provider.

The servicing entity server can receive, from the service provider server, an invoice for inventory warehousing, management, fulfillment, and/or distribution services with respect to the inventory items and, in response to receipt of the invoice, transmit instructions to transfer funds from an account associated with the servicing entity to an account associated with the service provider.

One or more of the database(s) can include data indicating that a warranty reserve for the inventory items was transferred by the original supplier to the servicing entity. Warranty claims can then be serviced by the service provider. The service provider server can send invoices for warranty servicing charges to the servicing entity server, and the servicing entity server effect wire transfer of funds to an account associated with the service provider.

When new inventory items are sold by the original supplier to the servicing entity, the original supplier server can effect wire transfer of funds to the servicing entity to cover any warranty claims on the new inventory items.

When one or more of the servers receive a customer purchase order for an item in inventory and one or more databases associated with an original supplier, service provider, and servicing entity comprise data indicating that the inventory item(s) was supplied by the original supplier and is in the custody and/or possession of the service provider, the present disclosure can include a method, system and/or computer readable medium, comprising microprocessor executable logic operable to:

send, by the service provider server to the servicing entity server, an inspection notice indicating whether the inventory item(s) are conforming or nonconforming with specifications and/or requirements of one or more of the customer, servicing entity, service provider, and original supplier;

send by the one or more of the original supplier server, service provider server, and servicing entity server to a financing entity server associated with a financing entity, a purchase notice indicating a term and/or provision of the customer purchase order, use of sales proceeds, and/or scheduled maturity date for each receivable secured by a loan extended to the servicing entity by the financing entity;

receive, by the one or more of the original supplier server, service provider server, and servicing entity server from the financing entity server, a confirmation notice indicating whether or not the purchase notice is acceptable to the financing entity;

when the inspection notice indicates that one or more of the inventory items are conforming and the confirmation notice indicates that the purchase order is acceptable to the financing entity, the servicing entity server effects payment of funds to the original supplier for the inventory items and/or sends to the original supplier server a payment notice indicating that funds will be paid to the original supplier for the inventory items; and

when the inspection notice indicates that the one or more of the inventory items are nonconforming and/or the confirmation notice indicates that the purchase order is unacceptable to the financing entity, the servicing entity server sends a notice to the original supplier server and/or service provider server that the one or more of the inventory items are not acceptable and/or that the proposed sale to the customer cannot be consummated.

When the confirmation notice indicates that the purchase order is acceptable, the financing entity server can cause transfer of funds to the servicing entity and/or original supplier for payment for the inventory items.

The customer server can cause transfer of funds to the servicing entity for payment for the inventory items after the financing entity server causes transfer of funds to the servicing entity.

The service provider server can send an invoice to the servicing entity server for inventory warehousing, management, fulfillment, and/or distribution services with respect to the inventory items and, in response, the servicing entity server can cause payment of appropriate funds to the service provider.

The inventory item(s) can be owned by the original supplier before the sending and receiving steps/operations are performed.

The service provider server can send to the servicing entity server an inventory report comprising one or more of accounts receivable, on-hand inventory level, and borrowing requests.

The present disclosure can include a method, system and/or computer readable medium, comprising microprocessor executable logic (e.g., an inventory pricing module) operable to:in response to receipt of a customer purchase order for one or more items of inventory, determine one or more of an interest rate and annual percentage rate to be charged by a financing entity to finance a purchase of the one or more items of inventory;

based, in part, on the interest rate and/or annual percentage rate, determine a unit price for the one or more items of inventory; and

provide, by or at the request of the inventory pricing module, the unit price to a customer responsible for the customer purchase order.

The inventory items can be owned by a servicing entity until ownership is transferred to the customer, the servicing entity can be owned and/or controlled by a provider of outsourced financial and legal administrative services, and inventory items can be in the possession of a service provider during servicing entity ownership.

The inventory pricing module, in determining the unit price, can additionally considers one or more of the following: inventory book value, inventory market value, inventory sales price, allocable management fees charged or to be charged by the servicing entity by the provider of outsourced financial and legal administrative services, and allocable service fees charged or to be charged to the servicing entity by the service provider.

The method inventory items can be different types of inventory. In that event, the allocation of a payment to a financing entity based on the interest rate and/or annual percentage rate can be based on a relative value of different inventory types, followed by allocation of the allocable share to the number of units in each inventory type.

The present disclosure can include a method, system and/or computer readable medium, comprising microprocessor executable logic (e.g., an inventory financing module) operable to:

determine one or more of an interest rate and annual percentage rate to be charged by a financing entity to finance one or more items of inventory;

determine a unit inventory cost and/or price based on the interest rate and/or annual percentage rate and on a loan principal attributable to the inventory items; and

compare to an existing unit cost and/or price based on an interest rate and/or annual percentage rate currently charged by a financing entity to finance the inventory items.

The one or more of an interest rate and annual percentage rate can correspond to a finance product.

The inventory financing module can further determine whether the finance product satisfies one or more predetermined factors and apply the following rules:

when the finance product does not satisfy the predetermined factor(s), the inventory financing module does not determine the unit inventory cost and/or price and/or does not perform the comparing step; and

when the finance product satisfies the predetermined factor(s), the inventory financing module determines the unit inventory cost and/or price and/or performs the comparing step.

The inventory financing module can obtain, by an internet search engine, information about multiple finance products offered by different financing entities.

The inventory financing module can recommend a subset of the multiple of the finance products to refinance the inventory items.

The predetermined factor(s) applied by the inventory financing module can include one or more of a maximum interest rate, a maximum annual percentage rate, a maximum refinancing cost, a maximum and/or minimum loan term, maximum points, maximum loan origination fees, minimum balloon payment amount, maximum balloon payment amount, balloon payment timing, maximum total amount owed, a percent reduction in interest rate and/or loan payments, and maximum absolute reduction in interest rate and/or loan payment.

The present disclosure can provide a number of advantages depending on the particular aspect, embodiment, and/or configuration. The present disclosure describes a fully or partially automated system and method that can provide a materials management warehousing and distribution solution able to save customers money while still fulfilling customer's inventory requirements. It can reduce original supplier costs, reduce original supplier risk from disposal of obsolete equipment (e.g., the service provider can recover assets and purchase at fair market value), improve budgeting for the original supplier by spreading the cost of technology over time, and improve original supplier service levels for full life-cycle spare parts distribution. It can overcome constraints caused by the cost of capital of the manufacturer. The price point offered by the service provider can at least be superior to the manufacturer's cost of capital. It can enable the original supplier to lock in multiple years of service at today's rates. It can establish predictable and manageable original supplier payments. It can manage spare part and other inventory obsolescence and relieve balance sheet requirements of original suppliers (such as OEM manufacturers) from the demanding requirements of long life-cycle system support. Relief of the balance sheet can maintain original supplier compliance with covenants, enable the original supplier to remain within capital constraints, and improve original supplier financial measures.

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic”, and variations thereof, refer to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “capital asset pricing model” or CAPM is typically used to determine a theoretically appropriate required rate of return of an asset, if that asset were to be added to an already well-diversified portfolio, given that asset's non-diversifiable risk. The model takes into account the asset's sensitivity to non-diversifiable risk (also known as systematic risk or market risk), often represented by the quantity beta (β) in the financial industry, as well as the expected returns of the market and a theoretical risk-free asset.

The term “computer-readable medium” refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The “cost of capital” refers to the cost of a company's funds (both debt and equity) and/or a shareholder's required return on a portfolio company's existing securities. It can be used to evaluate new projects of a company as it is typically the minimum return that investors expect for providing capital to the company, thus setting a benchmark that a new project has to meet. For an investment to be worthwhile, the expected return on capital commonly must be greater than the cost of capital. The cost of capital is the rate of return that capital could be expected to earn in an alternative investment of equivalent risk. If a project were to be of similar risk to a company's average business activities, it is reasonable to use the company's average cost of capital as a basis for the evaluation. A company's securities typically include both debt and equity. The company therefore commonly calculates both the cost of debt and the cost of equity to determine a company's cost of capital. The “cost of debt” is relatively simple to calculate, as it is typically composed of the rate of interest paid. In practice, the interest-rate paid by the company can be modeled as the risk-free rate plus a risk component (risk premium), which itself incorporates a probable rate of default (and amount of recovery given default). For companies with similar risk or credit ratings, the interest rate is largely exogenous (not linked to the cost of debt). The cost of equity is commonly defined as the risk-weighted projected return required by investors, where the return is largely unknown. The cost of equity can therefore be inferred by comparing the investment to other investments (comparable) with similar risk profiles to determine the “market” cost of equity. It is commonly determined using the CAPM formula, though it may be desirable to use an international CAPM as opposed to a local CAPM (which can depend on whether markets are fully integrated or segmented (if fully integrated, there would be no need for a local CAPM)). Once the costs of debt and equity have been determined, their blend, the weighted-average cost of capital (WACC), can be calculated. This WACC can then be used as a discount rate for a project's projected cash flows.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multivalue, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases.

“Database management systems” (DBMSs) are specially designed applications that interact with the user, other applications, and the database itself to capture and analyze data. A general-purpose database management system (DBMS) is a software system designed to allow the definition, creation, querying, update, and administration of databases. Well-known DBMSs include MySQL™, PostgreSQL™, SQLite™, Microsoft SQL Server™, Microsoft Access™, Oracle™, SAP™, dBASE™, FoxPro™, and IBM DB2™. A database is not generally portable across different DBMS, but different DBMSs can inter-operate by using standards such as SQL and ODBC or JDBC to allow a single application to work with more than one database.

The terms “determine”, “calculate” and “compute,” and variations thereof, are used interchangeably and include any type of methodology, process, mathematical operation or technique.

An “enterprise” refers to a business and/or governmental organization, such as a corporation, partnership, joint venture, agency, military branch, and the like.

“Inventory” or “stock” refers to the goods and/or materials that an enterprise holds for resale and/or repair. Examples of goods and materials, include raw materials, work-in-process, finished goods, goods for resale, stocks in transit, and consignment stocks.

“Inventory management” is specifies the size, shape, percentage, and/or placement of stocked goods. Inventory management is often required at different locations within a facility or within multiple locations of a supply network to protect the regular and planned course of production against the random disturbance of running out of materials or goods. The scope of inventory management can also concern the fine lines between replenishment lead time, carrying costs of inventory, asset management, inventory forecasting, inventory valuation, inventory visibility, future inventory price forecasting, physical inventory, available physical space for inventory, quality management, replenishment, returns and defective goods and demand forecasting.

“Inventory management software” is a computer-based system for tracking inventory levels, orders, sales and deliveries. It can also be used in the manufacturing and/or warehousing industries to create a work order, bill of materials, and other sales-related documents. Order management triggers inventory reordering or manufacturing when inventory teaches a predetermined threshold. Asset tracking can use a barcode, RFID tags, wireless tracking technology, and/or other tracking criteria, such as a serial number, lot number or revision number, to track not only movement of inventory within a warehouse or set of warehouses of a common enterprise but also shipment or other removal out of or from the warehousing system.

The term “means” shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

An “original equipment manufacturer”, or OEM, manufactures product or components that are purchased by another enterprise and retailed under that purchasing enterprise's brand name. OEM refers to an enterprise that originally manufactured the product. When referring to automotive parts for instance, OEM designates a replacement part made by the manufacturer of the original part.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of an inventory management system according to an embodiment of the present disclosure;

FIG. 2 is a block diagram of the microprocessor executable computational modules according to the embodiment;

FIG. 3 is a message flow diagram according to the embodiment;

FIG. 4 is a logic flow diagram of the original supplier purchasing module according to the embodiment;

FIG. 5 is a logic flow diagram of the service provider inventory management module according to the embodiment;

FIG. 6 is a logic flow diagram of the servicing entity purchasing and loan payment modules according to the embodiment;

FIG. 7 is a logic flow diagram of the loan management module 216 according to an embodiment;

FIG. 8 is a message flow diagram according to an embodiment of the disclosure;

FIGS. 9A-B is a logic flow diagram according to an embodiment of the disclosure;

FIG. 10 is a message flow diagram according to an embodiment of the disclosure;

FIG. 11 is a logic flow diagram according to an embodiment of the disclosure; and

FIG. 12 is a logic flow diagram according to an embodiment of the disclosure.

### DETAILED DESCRIPTION

### The Inventory Management System

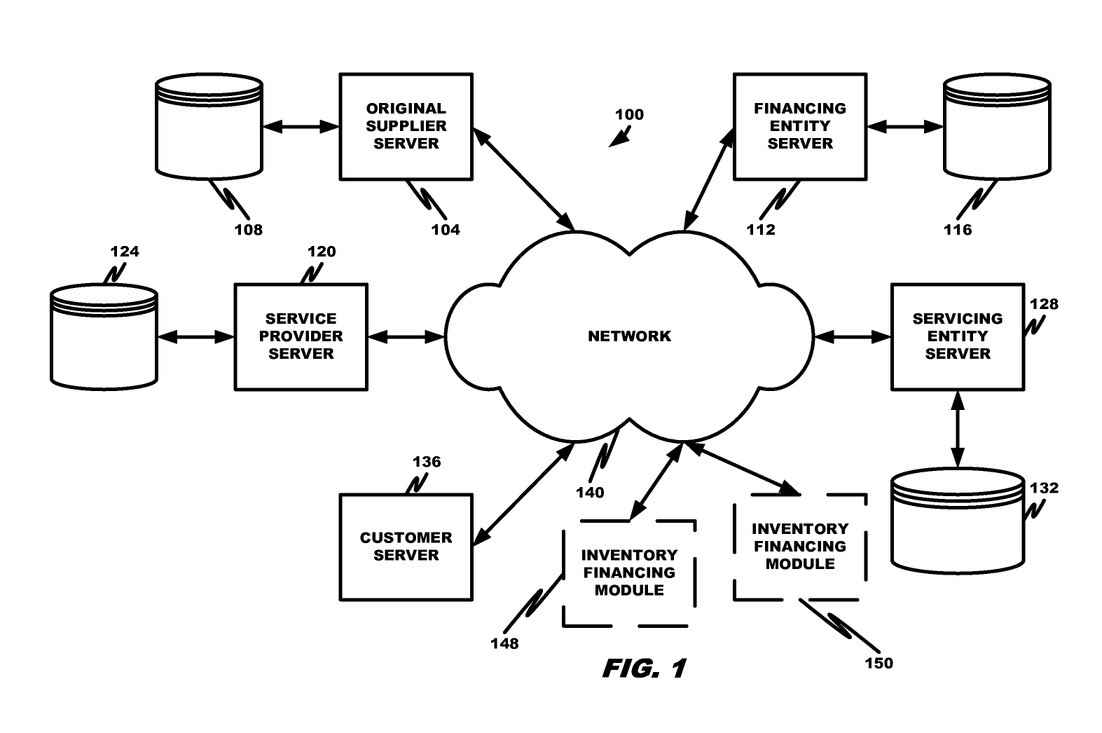

With reference to FIG. 1, the inventory management system 100 comprises an original supplier server 104, a financing entity server 112, a servicing entity server 128, a service provider server 120, corresponding databases 108, 116, 132, and 124 (each having a database management system), respectively, and a customer server 136 connected by a network 140. Each of the original supplier server 104, financing entity server 112, servicing entity server 128, service provider server 120, and customer server 136 are commonly associated with a different (e.g., independently owned and controlled and/or unaffiliated) enterprise. For example, the servicing entity can be a special purpose vehicle created for inventory ownership and inventory acquisition financing. The special purpose vehicle could be owned and managed by a provider of outsourced financial and legal administrative services.

The enterprises each serve different purposes in the inventory management system 100. The original supplier associated with the server 104 is typically a manufacturer and/or supplier of inventory items (such as an OEM), the financing entity associated with the server 112 is typically a lending or financial institution financing all or part of the sale of the inventory items, the servicing entity associated with the server 128 is typically a special purpose vehicle having title to the inventory items and acting as a borrower on the loan financing all or part of the sale of the inventory items, the service provider associated with the server 120 is typically a servicing entity-contracted organization acting as a consignor (or physical possessor of the inventory) responsible for inventory warehousing (e.g., as a custodian), management, fulfillment, financial management, and/or distribution on behalf of the servicing entity, and the customer associated with the customer server is typically an end user, distributor, retailer, wholesaler, or other purchaser of the inventory items. To effect inventory purchase by the servicing entity, the servicing entity server 128 sends to the original supplier server 104 a purchase order for the inventory. The purchased inventory is shipped by the original supplier, and the original supplier purchasing module 200 sends, via the original supplier server 104, to the servicing entity server 128 and/or optionally service provider server 120, a shipment notification providing the shipper, shipment date, expected shipment receipt date, and tracking number(s). When the inventory items are received at the service provider, the service provider inventory management module 208 provides, via the service provider server 120, an inventory receipt notice providing the details on the received inventory, such as number and type of inventory items, receipt date, identification of any damaged or nonconforming inventory items, and the like. The servicing entity server 128 and/or service provider server 120, on behalf of the servicing entity, effects fund transfer to the original supplier and/or a financial institution associated with the original supplier. Fund transfer is typically effected by transmitting wire transfer or other instructions to a financial institution having an account associated with the servicing entity to transfer funds from the account to an account associated with the original supplier. Payment notification, including payment details such as amount paid or transferred, date of payment or transfer, originating financial institution and account information, and receiving financial institution and account information, can be sent by the servicing entity server 128 and/or service provider server 120 to the original supplier server 104. Suitable database updates are performed by the original supplier to record payment and inventory transfer, by the service provider to update current inventory levels and/or quantities and types, and by the servicing entity to record payment and inventory transfer. While the service provider can move the purchased inventory to its facility for consignment, the service provider can also enter into a suitable purchase or lease arrangement with the original supplier to buy or lease all or a portion of the warehousing facility where the inventory is located before sale to the servicing entity. In the latter event, the service provider would assume possession of the inventory and all or part of the warehousing facility storing the inventory and install suitable equipment and personnel to perform inventory warehousing, management, fulfillment, and/or distribution on behalf of the servicing entity. When the inventory is shipped to a separate facility of the service provider, the service provider can issue, electronically via the service provider server 120 and network(s) 104, an indemnification letter to the servicing entity server 128 to cover lost and/or damaged inventory. The indemnification letter can be assigned by the servicing entity to the financing entity as collateral for the loan.

The contents of the databases 108, 116, 124, and 128 depend on the role of the corresponding enterprise. The database 108 of the original supplier, for example, includes, inter alia, sales records (e.g., order date, ship date, inventory identifiers, inventory quantity sold, sales price, purchaser identifier, and shipping records) for the sale of the inventory to the servicing entity and optionally the customer, customer on-hand inventory requirements (e.g., customer identifier and, for each customer identifier, inventory identifiers and required on-hand inventory levels or quantities), last reported inventory information (e.g., inventory identifiers and last reported on-hand levels or quantities), and cost of capital information. The database 116 of the financing entity includes, inter alia, loan identifier, borrower identification information (e.g., entity tax identifier, address, and entity type), borrower payment history (e.g., loan payments, interest paid, principal paid, and payment date), loan terms (e.g., interest rate and other payment terms), current principal and interest owed, last reported inventory levels or quantities), and cost of debt information. The database 124 of the service provider includes, inter alia, sales records (e.g., order date, ship date, inventory identifiers, inventory quantity sold, sales price, purchaser identifier, and shipping records) for the sale of the inventory to the customer, currently on-hand inventory levels and/or quantities (e.g., inventory identifiers and currently on-hand levels or quantities), last reported inventory information (e.g., inventory identifiers and last reported on-hand levels or quantities), service invoices provided to the servicing entity and payment history of servicing entity, and cost of capital information. The database 128 of the servicing entity includes, inter alia, sales records (e.g., order date, ship date, inventory identifiers, inventory quantity sold, sales price, purchaser identifier, and shipping records) for the sale of the inventory to the customer, last reported on-hand inventory levels and/or quantities (e.g., inventory identifiers and last reported on-hand levels or quantities), service invoices provided to the servicing entity and payment history of servicing entity, loan payment history (e.g., loan payments, interest paid, principal paid, and payment date), and loan terms (e.g., lender identifier, interest rate, and other payment terms), and current principal and interest owed. In some configurations where the service provider provides inventory financial management on behalf of the servicing entity, the databases 124 and 128 contain substantially the same information.

The network(s) 104 can be any wired or wireless, public or private, trusted or untrusted distributed processing network, including, for example, a local area network, wide area network (such as the World Wide Web), and/or a regional network, or combinations thereof. A common network(s) 104 uses the Transport Control Protocol (“TCP”) and/or Internet Protocol (“IP”). Generally, the original supplier, financing entity, service provider, servicing entity, and customer servers 104, 112, 120, 128, and 136 are independently maintained, part of different enterprise networks (and not part of a common enterprise network) (whereby users are not authorized or privileged to access internal parts of different ones of the networks), and federated. As will be appreciated, “federated” describes the inter-operation of two distinct, formally disconnected, telecommunications networks that may have different internal structures.

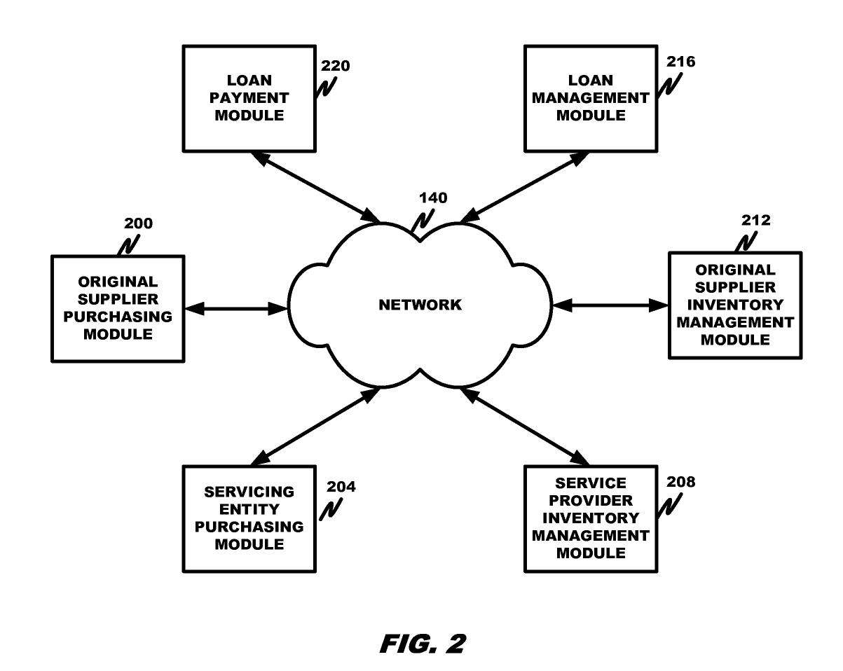

As shown in FIGS. 1 and 2, federated and networked servers, positioned physically and logically at each of the financing entity, original supplier, service provider, and servicing entity, contain or are locally in communication with dedicated computational modules.

The original supplier server 104, for example, can include or be in local communication with an original supplier purchasing module 200 to process purchases of inventory items by the customer and/or inventory management module 212 to monitor compliance of current servicing entity inventory levels with customer requirements. When it is determined that the currently on-hand inventory is in an out-of-compliance state or condition or nearing an out-of-compliance state or condition, the original supplier inventory management module 212 can cause the servicing entity to order from the original supplier additional inventory to restore the inventory levels to desired compliance levels. As current inventory level notifications or reports are received periodically from the servicing entity and/or service provider servers, the original supplier compares the inventory levels against inventory requirements and/or previously estimated inventory to determine whether new inventory needs to be acquired or manufactured. When new inventory is needed, an inventory needed notification is sent by the original supplier inventory management module 212 to the servicing entity and/or service provider servers, which then issue(s) a purchase order to the original supplier and/or other suppliers for the inventory items. In one implementation, the original supplier further does inventory planning or forecasting to ensure that inventory requirements are met.

The financing entity server 112 can include or be in local communication with a loan management module 216 not only to set loan pricing but also to determine periodic monthly loan servicing payments to be made by a loan payment module 220 in or in local communication with the servicing entity server 128. The financing entity can include an inventory financing module, or loan servicing software, to price initially the cost of the loan (or applicable cost of debt) using factors, such as risk(s), term(s), (book and/or fair market) inventory value(s), current debt of the servicing entity, loan amount, percentage of inventory value to be financed, credit rating of service provider and/or servicing entity, degree of capitalization of servicing entity, the debt capital market, state and federal loan requirements, (discounted) cash flow stream over life of loan, and the financing entity's cost of capital. The loan pricing information can be conveyed to one or more of the original supplier server 104, service provider server 120, and servicing entity server 128, via the network 140. In determining periodic loan servicing payments, the financing entity server 112 can also receive, from a service provider inventory management module 208 in or locally in communication with the servicing entity server 128, periodic inventory reports comprising on hand inventory item types and/or levels and/or values currently and/or as of the date certain, compute the interest payment for that period, invoice the servicing entity, and, in response to inventory sales, reduce the loan principal. The loan payment need not be keyed to or a function of the on-hand inventory levels and/or value but can be a fixed or variable monthly payment unrelated to inventory use and/or consumption. For example, it can include a principal and interest payment accrued over a selected period for all or part of the loan (e.g., daily, weekly, monthly, etc.).

The service provider can include an inventory management module 208 to monitor and control inventory to track additions and removals from inventory and send current inventory levels and book value(s) to one or more of the original supplier, servicing entity, and financing entity servers 104, 128, and 112, respectively. The service provider inventory management module 208 commonly includes inventory management software using inventory item identifiers (e.g., skews) that are unique to a type of item or part to track current on-hand inventory levels. In other configurations, the service provider management module 208 (and not the original supplier inventory management module 212) determines when customer requirements for a selected type of inventory item are no longer being met or in danger of not being met and issues an appropriate order to the original supplier server 104 to obtain more of such item for purchase by the servicing entity and, when received, increases inventory levels for the item(s). The service provider inventory management module 208 further can receive purchase orders, either directly from the original supplier server and/or customer or indirectly through the servicing entity server, for inventory items purchased by the customer, ship the items to a specified customer location, and proportionally decrease inventory levels as a result. The servicing entity server and/or service provider server, in turn, can generate an invoice to the original supplier server for the book value plus invoiced service provider servicing costs of the purchased inventory items. Alternatively, the unit price of the inventory can be a function of the book or market value of the inventory, allocable management fees charged to the servicing entity by a provider of outsourced financial and legal administrative services controlling and/or managing the servicing entity, the allocable service fees charged to the servicing entity by the service provider, and the allocable financing charges of the financing entity. The allocation of the charges to units of inventory can be done on any suitable basis. Where different types of inventory items are involved, the allocation among inventory types can first be performed based on relative values of the inventory types, followed by allocation of the allocable share to the number of units in each inventory type. Stated another way, the original supplier server can receive orders from the customer server, place purchase orders to the servicing entity and/or service provider servers, receive invoices for sold inventory from the servicing entity and/or service provider server, and arrange payment therefor. The service provider inventory management module 208 can also generate and send to the servicing entity server periodic invoices for inventory warehousing, management, fulfillment, and/or distribution services and/or invoice the original supplier, servicing entity, and/or customer for inventory sales. The total invoice provided by the service provider to the original supplier, servicing entity, and/or customer can include one or more of sold inventory cost (e.g., fair market or book value), transaction fees, financing fees (of the financing entity) allocable to the sold inventory and/or accrued over a selected period for the entire loan (e.g., daily, weekly, monthly, etc.) and service fees of the service provider). The service provider can alternatively include the services as part of the inventory sales or transaction costs.

The servicing entity server 128 can include or be in local communication with the service entity purchasing module 204 to process purchases of inventory items by the customer and/or order inventory items from the original supplier in response to inventory needed notification receipt and/or the loan payment module 220 to handle loan payments to the financing entity. The operations of the service entity purchasing and loan payment modules 204 and 220 have been described above.

When the service provider provides inventory finance management on behalf of the servicing entity, the service provider server includes or is in local communication with the servicing entity purchasing module 204 to process purchases of inventory items by the customer and/or order inventory items from the original supplier in response to inventory needed notification receipt and/or the loan payment module 220 to handle loan payments to the financing entity.

The servicing entity can agree to sell the purchased inventory back to the original supplier on or before a stipulated purchase date. The commitment letter to purchase the inventory can be conditional or unconditional and typically is on, after, or near the customer required term for inventory to be maintained for a previously sold product. The original supplier can either pay the total of the commitment letter or the total of the purchased in inventory items and issue a new commitment letter for the remaining inventory items with a new, future last date of purchase. To effect repurchase of the inventory, the original supplier server 104 forwards to the servicing entity server 128, service provider server 120, and/or financing entity server 112 (as the financing entity may need to approve the sale) a purchase order for the inventory. When necessary, the servicing entity server 128 forwards the purchase order to the service provider server 120 or generates and forwards a new purchase order, based on the original supplier purchase order. The service provider ships the purchased inventory items to the original supplier and sends a shipment notification, by the service provider server 120, to each of the original supplier server 104, servicing entity server 128, and/or financing entity server 112. The original supplier is invoiced by one of the service provider server 120 or servicing entity server 128. The original supplier server 104 effects fund transfer to the financing entity, servicing entity, or the service provider. Fund transfer is typically effected by transmitting wire transfer or other instructions to a financial institution having an account associated with the original supplier to transfer funds from the account to an account associated with one or more of the financing entity, servicing entity and/or service provider. Payment notification can be sent by the original supplier server 104 to the financing entity server 112, servicing entity server 128, and/or the service provider server 120, as appropriate. The original supplier, financing, service provider, and servicing entity databases 108, 112, 124, and 132 are updated to reflect the inventory shipment and payment.

A number of examples illustrate the operation of the inventory management system 100.

By way of illustration, a special purpose vehicle (SPV) (such as a corporation, partnership, or other legal entity) is created as the servicing entity that is owned in whole or part by a third party independent of the service provider, original supplier, customer, and financing entity. “Independent” means that the third party is not controlled by or under common control with any one or more of the service provider, original supplier, customer, and financing entity. The inventory is purchased from the original supplier (e.g., OEM and/or the OEM's suppliers) by the servicing entity using third party (e.g., financing entity) debt financing (which is collateralized by the inventory and stipulated contract terms and is generally nonrecourse). The terms of financing (e.g., interest rate) commonly depend on lender requirements, minimum cost of debt capital, the term of the loan, the minimum cost of capital to the customer. From the financing entity's perspective, the loan is commonly collateralized not only by the inventory but also a share of the revenue stream received for inventory purchases by the original supplier (which share pays down the loan principal) and further secured by a “put” option enabling the financing entity to sell the inventory to the original supplier and/or customer. The interest charged monthly is typically a function of the book value of the inventory in existence on a date certain, such as at the end of the month. Periodic interest accrues based upon the agreed-to-cost of financing and the prevailing value of inventory owned by the servicing entity, net of ongoing inventory replenishment and consumption. From the servicing entity's perspective, it can sell, at book value plus the cost of financing, inventory warehousing, management, fulfillment, and/or distribution services provided by the service provider, and/or inventory transaction fees the inventory to the original supplier (with a share of the sales going to the financing entity as noted) for sale by the original supplier to the end customer at a market value price. The monthly service charge from the servicing entity to the original supplier typically varies month-to-month in direct relation to variation in the interest charged to the servicing entity and the volume of inventory items distributed to customers in support of the program.

### Methods of Operation

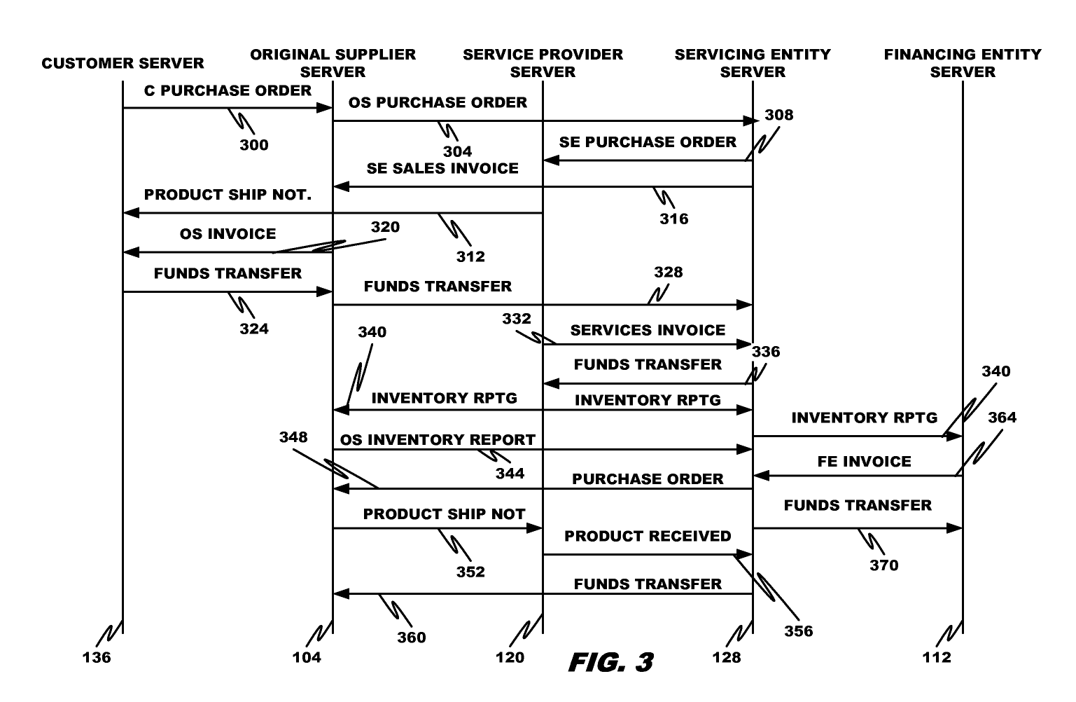

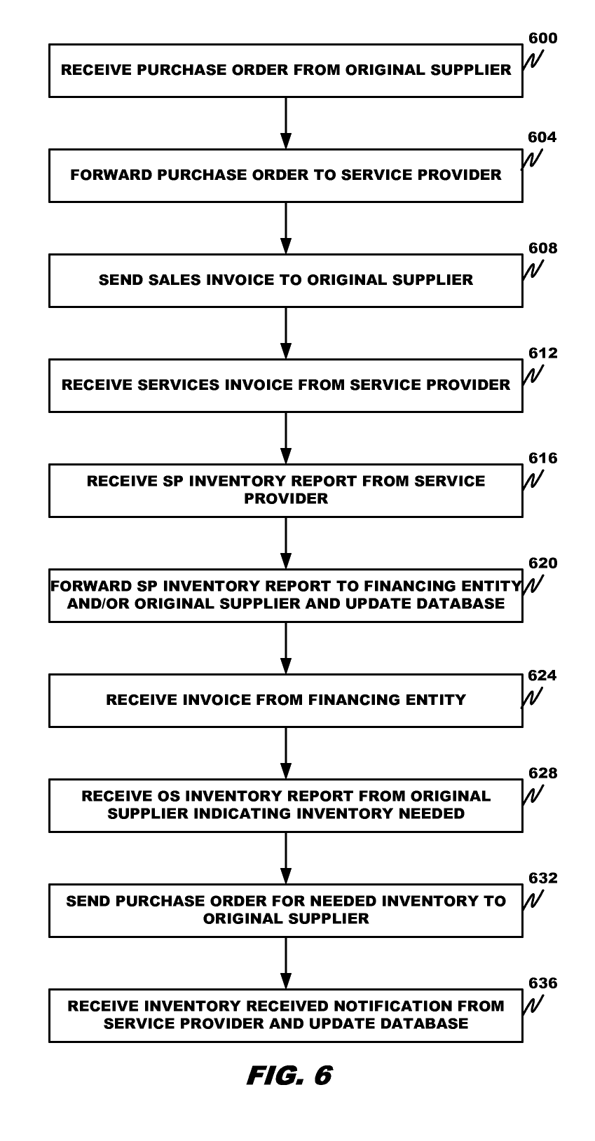

A fully or partially automated operation of this example according to one embodiment will now be discussed with reference to FIGS. 3-7.

The customer server 136 transmits a customer (“C”) purchase order 300 to the original supplier server 104. In step 400, the original supplier purchasing module 200 receives the customer purchase order and updates the original supplier database 108 to reflect same. In step 404, the original supplier purchasing module 200 forwards the customer purchase order, or generates and sends an original supplier (“OS”) purchase order 304, to the servicing entity server 128 and/or service provider server 120. The servicing entity purchasing module 204, in step 600, receives the purchase order from the original supplier and updates the servicing entity database 132 to reflect same.

In step 604, the servicing entity purchasing module 204, in step 604, can forward the customer or original supplier purchase order or generate and send a servicing entity (“SE”) purchase order 308 to the service provider server 120. In step 500, the service provider server 120 receives the purchase order from the servicing entity server 128, updates the service provider database 124 and, in step 504, ships the ordered product(s) directly to the customer. A product shipment notification 312 confirming shipment and providing details regarding same is sent by the service provider server 120 to the customer server 136 and/or the original supplier 104.

In step 606, the servicing entity purchasing module 204 in the servicing entity server 128 (and/or service provider server 120) generates and sends a servicing entity (“SE”) sales invoice 316 to the original supplier server 104. The original supplier server 104 receives the SE sales invoice 316 in step 408 and updates the servicing entity database 132 to reflect same. The original supplier purchasing module 200, in step 412, sends the SE sales invoice, or a newly generated original supplier (“OS”) sales invoice 320 based thereon, to the customer server 136. The customer server 136 effects a transfer of funds 324, via the customer server 136, from a financial institution associated with the customer to the original supplier or a financial institution associated therewith. Fund transfer is typically effected by transmitting wire transfer or other instructions to the financial institution having an account associated with the customer to transfer funds from the account to an account associated with one or more of the original supplier. The customer server 136 can send a payment notification to the original supplier server 104. The original supplier purchasing module 200 updates the original supplier database 108 to reflect payment of the invoice. The original supplier purchasing module 200, in response, independently effects transfer, via the original supplier server 104, of funds 328 from a financial institution associated with the original supplier to the servicing entity or a financial institution associated therewith. Fund transfer is typically effected by transmitting wire transfer or other instructions to a financial institution having an account associated with the original supplier to transfer funds from the account to an account associated with the servicing entity. The original supplier purchasing module 200 can send a payment notification to the servicing entity server 128. The servicing entity purchasing module 204 updates the servicing entity database 132 to reflect payment of the invoice.

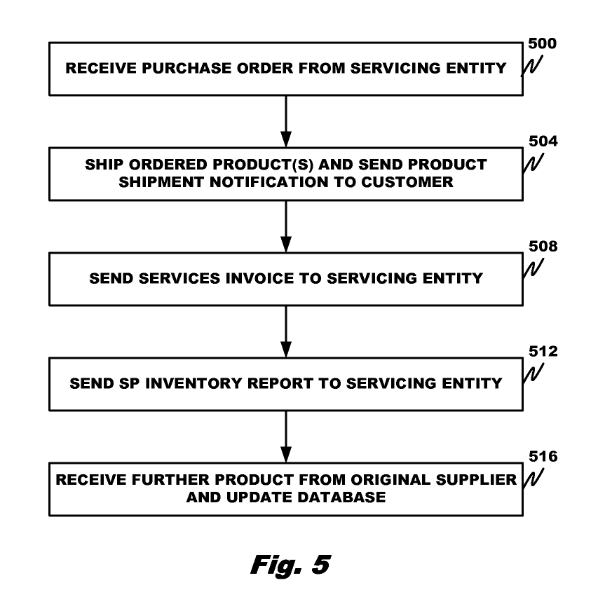

Referring to FIG. 5, the service provider inventory management module 208, via the service provider server 120, in step 508, generates and sends a services invoice 332 to the servicing entity server 128. The servicing entity server 128, in step 610, receives the services invoice 332, updates the servicing entity database 132 to reflect same, and effects transfer of funds 336, via the servicing entity server 128, from a financial institution associated with the servicing entity to the service provider or a financial institution associated therewith. Fund transfer is typically effected by transmitting wire transfer or other instructions to a financial institution having an account associated with the servicing entity to transfer funds from the account to an account associated with the service provider. The servicing entity server 128 can send a payment notification to the service provider server 120.

Referring again to FIG. 5, the service provider inventory management module 208, via the service provider server 120, in step 512, generates and sends an inventory report 340 to the servicing entity server 128 and, optionally, to the original supplier server 104 and/or financing entity server 128. The servicing entity server 128, in step 614 receives the inventory report 340 and updates the servicing entity database 132 to reflect same. When not previously provided by the service provider, the servicing entity server 128 forwards the inventory report 340 to the financing entity server 112 and/or original supplier server 104.

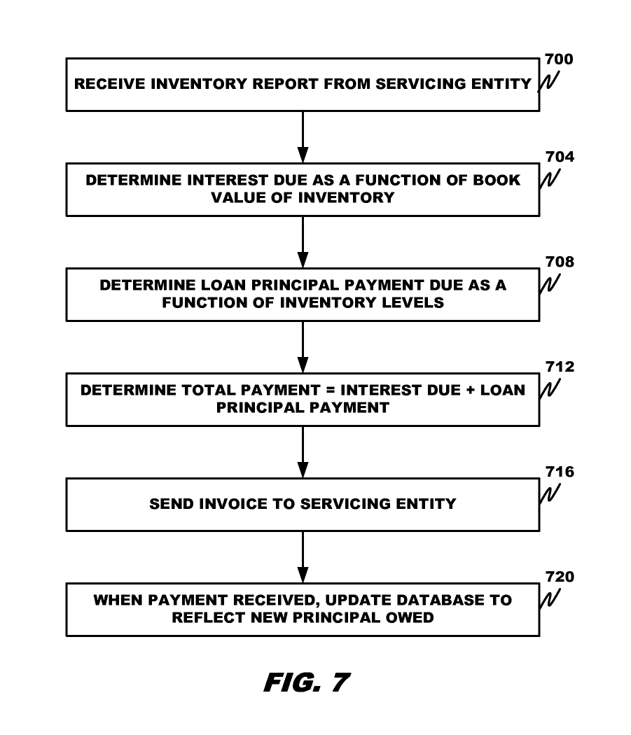

Referring to FIG. 7, the financing entity server 112 receives the inventory report 340 in step 700 and updates the financing entity database 116 to reflect same. In step 704, the loan management module 216 determines the interest due as a function of book value of the inventory or some other measure. In step 708, the loan management module 216 determines the loan principal payment due as a function of inventory levels or some other measure. In step 712, the loan management module 216 determines the total loan installment due and payable as the sum of the interest due and the loan principal payment. In step 716, the loan management module 216 updates the database 116 and generates and sends an invoice 364 setting forth payment details to the servicing entity server 128 and/or service provider server 120. In step 622, the servicing entity server 128 and/or service provider server 120 receives the invoice 364, the loan payment module 220 updates the servicing entity database 132 to reflect same and payment thereof, and the loan payment module 220 effects, via the servicing entity server 128, a transfer of funds 370 from a financial institution associated with the servicing entity to an account associated with the financing entity and optionally sends notification of payment. Fund transfer is typically effected by transmitting wire transfer or other instructions to a financial institution having an account associated with the servicing entity to transfer funds from the account to an account associated with the financing entity. In step 720, the financing entity server 112 receives payment and/or notification of payment, and the loan management module 216 updates the financing entity database 116 to reflect the payment and new principal balance owed.

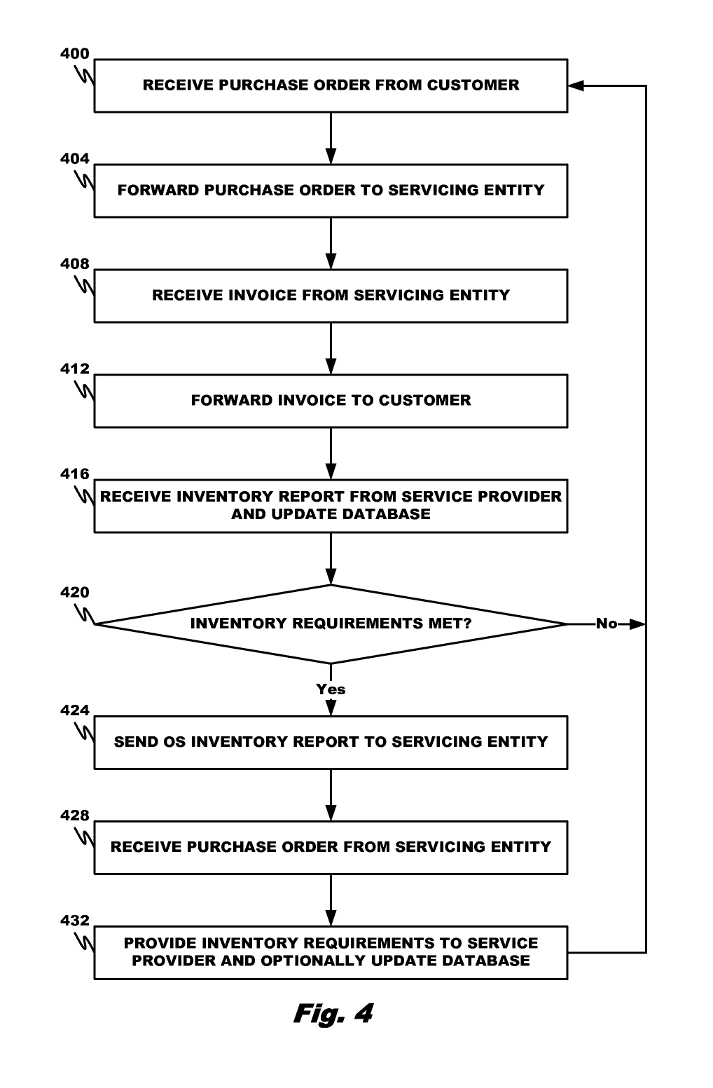

Referring to FIG. 4, the original supplier inventory management module 212, in step 416, receives the inventory report 340 and updates the original supplier database 108 to reflect same. In decision diamond 420, the original supplier inventory management module 212 determines whether customer inventory requirements are met. The inventory requirements, for example, can stipulate that a certain level or quantity of inventory items be maintained for a specific product or product(s) for a specified period of time. When the requirements continue to be satisfied, notwithstanding inventory reductions from the inventory item sale to the customer, the original supplier inventory management module 212 returns to step 400. A compliance notification can be sent to the servicing entity and/or service provider servers 128 and 120, respectively. When the requirements are not satisfied, or are in danger of not being satisfied, due to inventory reductions from the inventory item sale to the customer, the original supplier inventory management module 212, in step 424, sends an original supplier (“OS”) inventory report to the servicing entity server 128 indicating noncompliance. The inventory report provides information on whether or not, and to what degree, current inventory levels are in compliance with customer requirements and what customer requirements apply. The servicing entity server 128, in step 626, receives the inventory report 344, updates the servicing entity database 132 to reflect same, and, in step 630, the servicing entity purchasing module 204 generates and sends, via the servicing server 128 and/or service provider server 120, a purchase order 348 for needed inventory to the original supplier server 104. In step 428, the original supplier server 104 receives the purchase order 348 from the servicing entity and/or service provider server, updates the original supplier database 108 to reflect same, and causes the original supplier, in step 432, to manufacture and ship the required inventory items to the service provider and optionally update the original supplier database to reflect shipment of the inventory items. A shipment notification 352 can be sent by the original supplier server 104 to one or both of the servicing entity server 128 and service provider server 120 confirming shipment and providing details regarding same. In step 516, the service provider server 120 determines, such as from notification of the service provider inventory management module 208, that the ordered inventory items have arrived at the service provider facility and updates the service provider database 124 to reflect same. The service provider server 120 then sends an inventory received notification 356 to the servicing entity server 128. Upon receipt, the servicing entity server 128, in step 634, receives the inventory received notification 356 and updates the servicing entity database 132 accordingly. The servicing entity purchasing module 204 effects transfer of funds 360, via the servicing entity server 128, from a financial institution associated with the servicing entity to the original supplier or a financial institution associated therewith. Fund transfer is typically effected by transmitting wire transfer or other instructions to a financial institution having an account associated with the servicing entity to transfer funds from the account to an account associated with one or more of the original supplier. The servicing entity server 128 can send a payment notification to the original supplier server 104, which updates the service provider database 108 to reflect payment.

In another example, the inventory is sold by the original supplier to the servicing entity but the customer issues customer “C” purchase orders to the servicing entity and/or service provider server(s) rather than the original supplier server. The customer, for instance, enters into a supply agreement to purchase inventory items from the servicing entity, such as by irrevocable purchase orders. The original supplier enters into supply contracts with the servicing entity whereby the servicing entity and/or service provider, on behalf of the servicing entity server(s), issues purchase orders, which are typically irrevocable, to the original supplier server for additional inventory to meet customer requirements. The original supplier's invoice to the servicing entity requires payment in “Y” days from the date of shipment, issuance of the invoice, and/or date of the purchase order. The customer is invoiced by the servicing entity to pay for the purchased inventory items within a determined number of days “X” of issuance of a bill of lading for purchase of inventory items, commonly for the purchase of inventory items by the servicing entity from the original supplier. Generally, the customer is not required to pay until after the servicing entity is required to pay the original supplier. Before shipment to the servicing entity, service provider, and/or customer, the service provider inspects and the service provider server provides written confirmation, to the servicing entity server, of acceptance of quality of the inventory items based on inspection of pre-shipment samples of the inventory items. The inspection notice can indicate, for example, whether the inventory item(s) are conforming or nonconforming with specifications and/or requirements of one or more of the customer, servicing entity, service provider, and original supplier. The service provider server, acting on behalf of the servicing entity, generates and/or presents a purchase notice to the financing entity server detailing use of sales proceeds (e.g., the payments that are being made pursuant to invoices issued by the original supplier and the payment instructions including bank account details for a wire transfer from the financing entity to the original supplier) and the advance amount including the eligible receivables payable by the customer (e.g., the original supplier (“OS”) invoice number, OS invoice amount, servicing entity (“SE”) purchase order number, and scheduled maturity date for each receivable secured by the loan extended by the financing entity) and the inventory items (e.g., list of inventory items, date of the initial register in the books and records of the servicing entity, and the value of each inventory item). The financing entity confirms by confirmation notice sent by the financing entity server to the servicing entity and/or service provider server(s) that the terms of the purchase notice are acceptable. When the purchase notice is found to be acceptable, the servicing entity can use funds from the financing entity to pay for the purchase of the inventory items from the original supplier. The funds can be remitted directly to the original supplier on behalf of the servicing entity. By a warehouse control agreement with the original supplier, the service provider, acting as the inventory agent warehousing the inventory and acting under irrevocable instructions from the servicing entity to ship goods comprised of the inventory items to the customer, ships the purchased inventory items to the customer. The service provider can be paid a fee by the servicing entity based on logistics services provided by the service provider and/or a servicing fee or “finders fee” from inventory financing (e.g., 1% of inventory value). The servicing entity and/or service provider server(s) invoice the customer along with a fee that covers both the interest charged by the financial entity and the servicing fee charged by the service provider. The servicing entity, when payment is received from the customer, pays the financing entity principal and interest and the service provider its service fee. The service provider server provides, to the servicing entity, reports detailing accounts receivable and payable, on-hand inventory levels, borrowing requests, and the like. The financing entity's loan is secured by the inventory of inventory items acquired from the original supplier by the servicing entity and all the receivables arising from the sale of such inventory items to the customer.

By way of illustration, a customer in one country and/or location desires to purchase inventory from an original supplier in a different (remotely located) country and/or location. The shipment duration from the original supplier's facility to the customer's facility takes several weeks. By taking ownership of the purchased inventory at the shipping terminal at the seller's location, the customer is required by GAAP to reflect the in-transit inventory on its books and records. To overcome this requirement, the servicing entity is owned and controlled by a business enterprise and/or entity independent of the servicing entity parent enterprise, which for example can be an enterprise providing fee-based administrative and corporate governance services to the structured finance industry. The service provider handles inventory management (which includes inventory warehousing, management, fulfillment, and/or distribution services), inventory financial management (which includes receiving, processing, and generating purchase orders, providing accounts receivable reports, handling accounts payable, interacting with the financing entity (such as by handling borrowing requests), and purchase order invoicing and payments). The service provider, at no time, owns any portion of the inventory. In this manner, the inventory is not required, under GAAP and after the sale, to appear on the books (e.g., balance sheet) and asset-related accounting records of the customer, service provider, or original supplier. The cost of capital to the customer or service provider is therefore not required to be satisfied during the period between shipment and receipt of the inventory. Effectively, the servicing entity and service provider hold the inventory on credit financed by the financing entity until the customer is ready to receive, and take ownership of, the inventory. Stated another way, the financing entity provides financing to the servicing entity to bridge the funding gap between customer payment to the servicing entity and servicing entity payment to the original supplier. Even if it were, the inventory unitized sum total cost of the cost components for temporarily financing the inventory purchase by the servicing entity (until the inventory is received at the customer's facility at which point title transfers from the servicing entity to the customer), for the management fees of the enterprise owning, controlling, and managing the servicing entity, and for the service provider services is typically substantially less than the customer's cost of capital during the same period assuming a more traditional inventory sale between the original supplier and customer in which title passes upon inventory shipment.

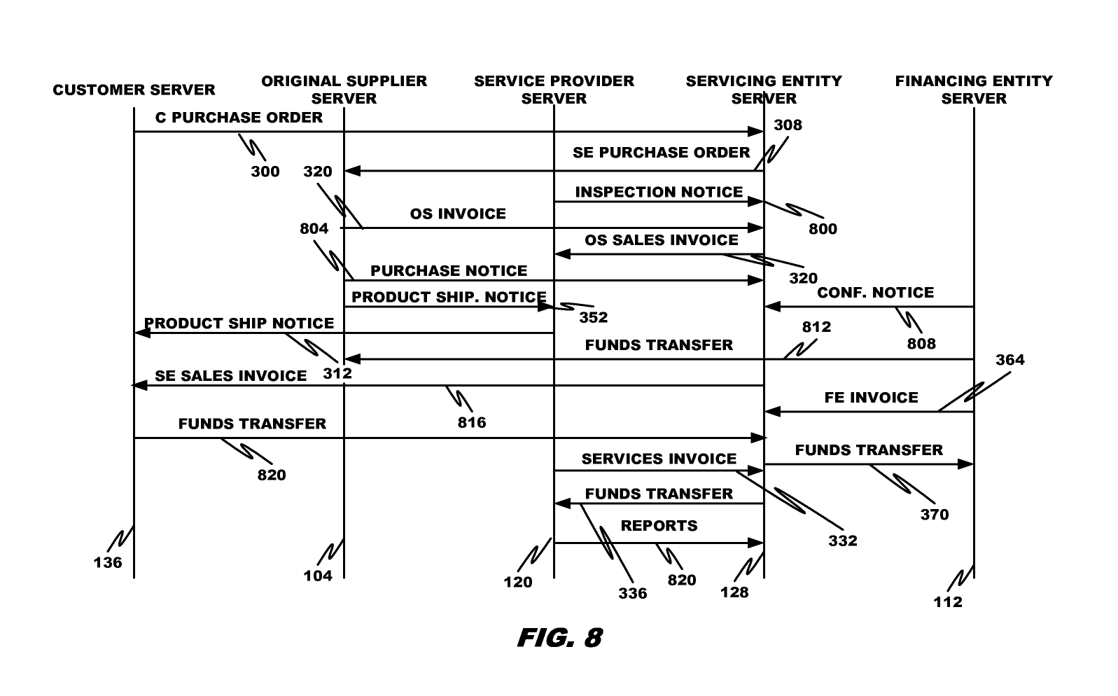

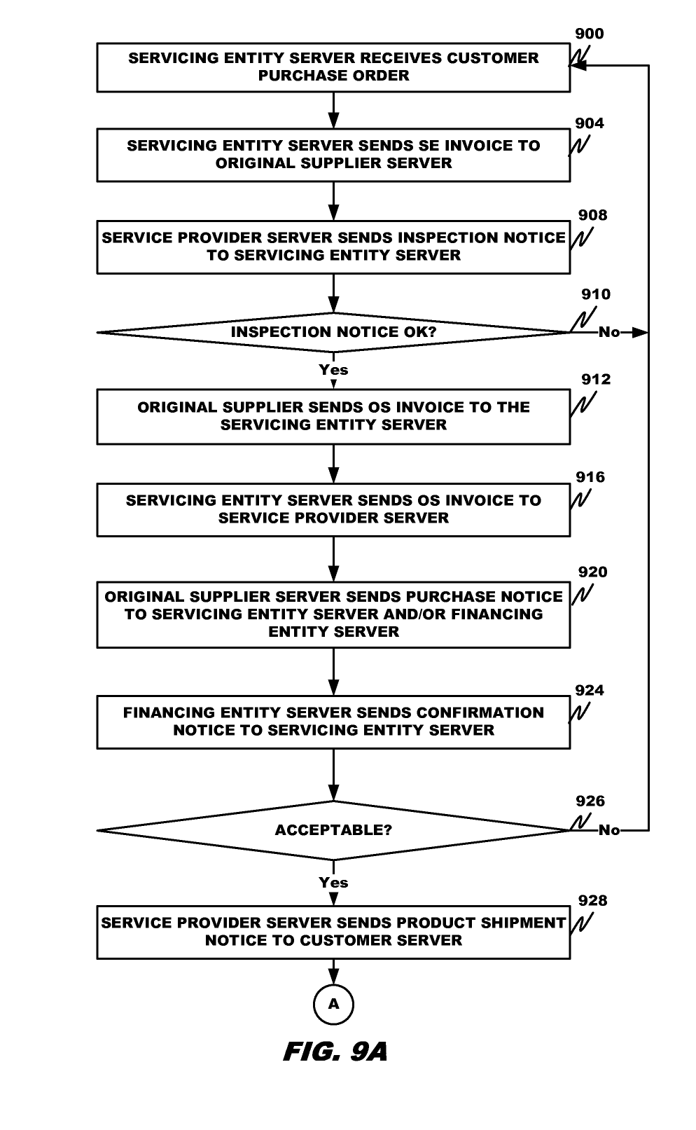

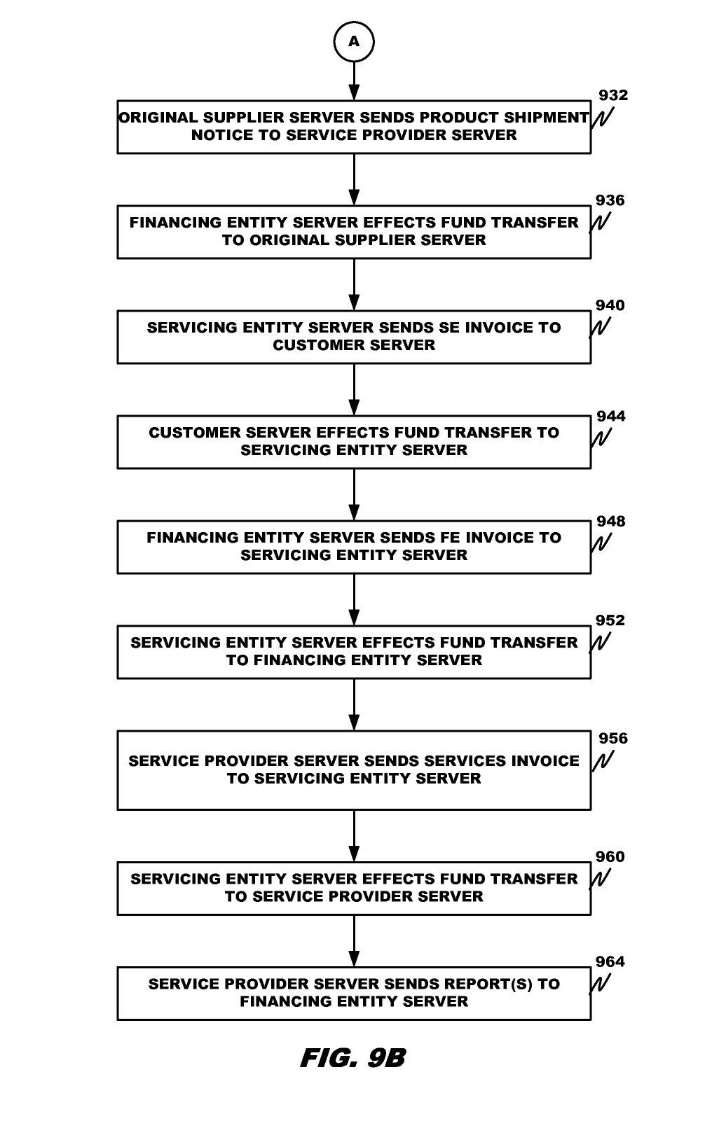

Referring to FIGS. 8 and 9A-B, a fully or partially automated operation of this example according to one embodiment will now be discussed.

In step 900, a servicing entity server 128 and/or service provider server 120 receives a customer purchase order 300 and updates the servicing entity database 132 and/or service provider database 124 to reflect same.

In step 904, the servicing entity server 128 and/or service provider server 120 forwards the customer purchase order or a servicing entity invoice 308 derived therefrom to the original supplier server 104 and, when appropriate, service provider server 120. The original supplier server 104 and service provider server 120 update the original supplier database 108 and service provider database 124, respectively, to reflect the same.

In step 908, the service provider server 120 sends an inspection notice 800 to the servicing entity server 128. The inspection notice 800 includes confirmation that the inventory items were inspected by the service provider and found to be substantially or identically conforming or nonconforming to the terms of the customer purchase order and/or other specifications and qualifications of the original supplier and/or servicing entity. The service provider server 120 and servicing entity server 128 update their respective databases 124 and 132 to reflect the same.

In decision diamond 910, the servicing entity server 128 determines whether or not the inspection notice is acceptable. When the inventory is nonconforming processing of the transaction is terminated, and the servicing entity server 128 returns to step 900 to await receipt of a next customer purchase order. A termination notification regarding the current purchase order and reason therefor can be provided by the servicing entity server 128 to the customer server 136 and/or the original supplier server 104. The stated reason can identify what inventory item types or items are considered to be nonconforming. The original supplier can elect to cure the nonconforming inventory either by replacing the nonconforming inventory items with conforming inventory items or repairing the defects in the nonconforming inventory items. Either way, the original supplier server 104 sends a cure notification to the service provider server 120 and/or servicing entity server 128 requesting a new inspection to be conducted. A new inspection notice would then be generated and sent as before. When the inventory is conforming, the servicing entity server 128 continues processing the purchase order.

In step 912, the original supplier server 104 sends an original supplier invoice 320 to the servicing entity server 128 and/or service provider server 120, which updates the servicing entity database 132 to reflect the same.

In step 916, the servicing entity server 128, when appropriate, sends the original supplier invoice 320 to the service provider server 120, which updates the service provider database 124 to reflect the same.

In step 920, the original supplier server 104 sends a purchase notice 804 to the servicing entity server 128 and/or financing entity server 112, which update a respective database to reflect the same.

In step 924, the financing entity server 112 sends a confirmation notice 808 to the servicing entity server 128, which update the servicing entity database 132 to reflect the same.

In decision diamond 926, the servicing entity server 128 determines whether or not the terms and conditions of the proposed inventory purchase or sale are acceptable. When the confirmation indicates that the terms and conditions of the proposed inventory purchase or sale by the servicing entity are unacceptable, the transaction is terminated and the servicing entity server 128 returns to step 900 to await receipt of a next purchase order. Processing on the current purchase order is terminated. A termination notification regarding the current purchase order and reason therefor can be provided by the servicing entity server 128 and/or service provider server 120 to the customer server 136 and/or original supplier server 104. When the confirmation indicates that the terms and conditions are acceptable, processing of the purchase order continues.

In step 928, the original supplier server 104 sends a product shipment notice to the service provider server 120, which updates its database 124.

In step 932, the service provider server 120 sends a product shipment notice 312 to the customer server 136.

In step 936, the financing entity server 112 effects fund(s) 812 transfer to the original supplier or a financial institution associated therewith. Fund transfer is typically effected by transmitting wire transfer or other instructions to a financial institution having an account associated with the financing entity to transfer funds from the account to an account associated with the original supplier. The financing entity server 112 can send a payment notification to the original supplier server 104. The financing entity and original supplier databases 116 and 108 are updated to reflect payment as noted above.

In step 940, the servicing entity server 128 and/or service provider server 120 sends a servicing entity invoice 816 to the customer server 136. The invoice sets forth the inventory items purchased and the sales and payment terms.

In step 944, the customer server 136 effects fund(s) 820 transfer to the servicing entity or a financial institution associated therewith. Fund transfer is typically effected by transmitting wire transfer or other instructions to a financial institution having an account associated with the customer to transfer funds from the account to an account associated with the servicing entity. The customer server 136 can send a payment notification to the servicing entity server 128. The servicing entity database 132 is updated to reflect payment as noted above.

In step 948, the financing entity server 112 sends a financing entity invoice to the servicing entity server 128, which updates its database to reflect the same. In response, the servicing entity server 128 and/or service provider server 120 effects fund(s) 370 transfer to the financing entity or a financial institution associated therewith. Fund transfer is typically effected by transmitting wire transfer or other instructions to a financial institution having an account associated with the servicing entity to transfer funds from the account to an account associated with the financing entity. The servicing entity server 128 and/or service provider server 120 can send a payment notification to the financing entity server 112. The servicing entity, service provider, and financing entity databases 132, 124, and 112 are updated to reflect payment as noted above.

In step 956, the service provider server 120 sends a services invoice 332 to the servicing entity server 112, which updates its database to reflect the same.

In step 960, the servicing entity server 128 effects fund(s) 336 transfer to the service provider. Fund transfer is typically effected by transmitting wire transfer or other instructions to a financial institution having an account associated with the servicing entity to transfer funds from the account to an account associated with the service provider. Payment notification can be sent from the servicing entity server 128 to the service provider server 120. The servicing entity and service provider databases 132 and 124 are updated to reflect payment.

In step 964, the service provider server 120 sends report(s) to the financing entity server 116 as noted above. The financing entity database 112 is updated to reflect the content of the records.

The disclosure can further include an outsourced warranty management program. The servicing entity can further assume warranty liability for the inventory items. It can hold reserves sufficient to cover expected claims. All or part of this reserve can be provided by the original supplier in exchange for the servicing entity assuming the warranty liability. Additional warranty coverage can be issued as new inventory items are received. The fees for the additional coverage can be provided by the original supplier, such as in response to an invoice issued by the servicing entity or service provider. The service provider can receive claims, provide forward logistics, reverse logistics, and repair services to support installed or sold inventory items, and issue claims to and receive payment from the servicing entity for the warranty cost incurred. In the event of inventory repurchase by the original supplier, the warranty reserve can be returned to the original supplier in exchange for the original supplier assuming the warranty liability. An insurer owned in whole or part by the service provider can be assigned the reserve and assume the warranty liability in which event it would be responsible for paying the service provider for warranty-related services.

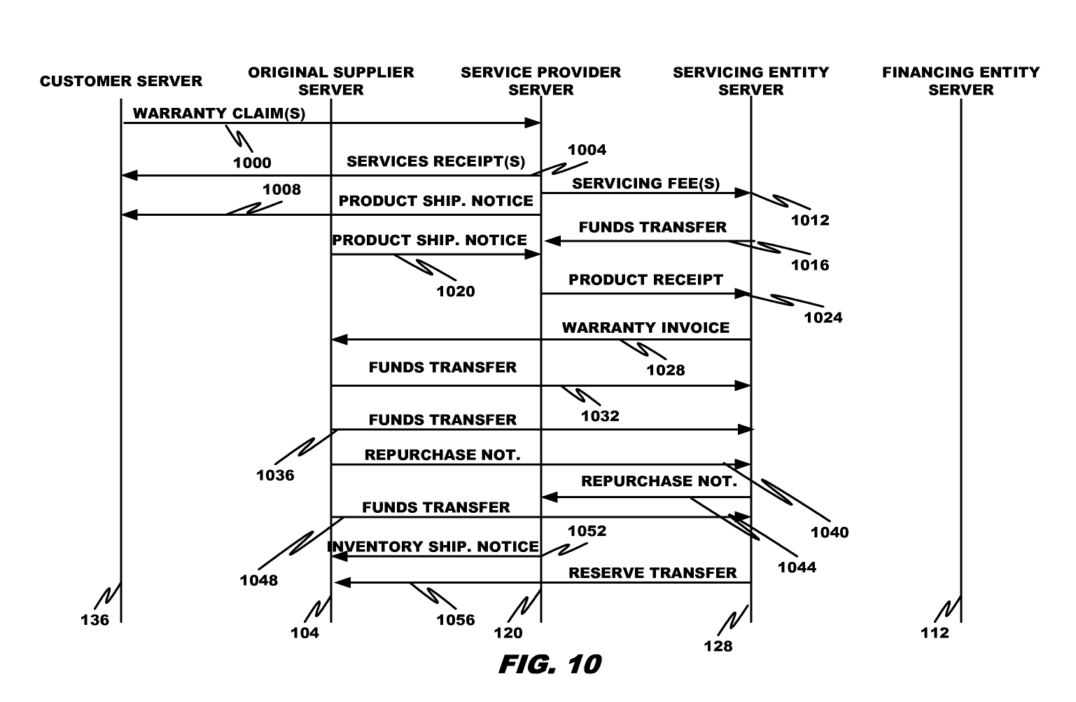

A fully or partially automated example will be discussed with reference to FIG. 10. This example assumes that the warranty claim reserve has been transferred to the servicing entity by the original supplier as evidenced by transmission from the original supplier server 104 to the servicing entity server 128 of account details for the reserve, with updates being made in both the original supplier database 108 and servicing entity database 132 indicating that the reserve is no longer owned by the original supplier but is now owned by the servicing entity.

A customer server 136 sends one or more warranty claim(s) 1000 to the service provider server 120, which updates the service provider server 120 including creating one or more work order(s) for the warranty claim(s).

In response, the service provider server 120 sends one or more services receipts 1004 indicating a charge for repairing the asserted defects in the inventory items. The receipts include covered charges and uncovered charges. Covered charges are charges covered under an applicable warranty, and uncovered charges are not covered and must be paid by the customer. Where the asserted defects are not covered by a warranty, the service provider 120 can return the inventory items and send a service denial request to the customer server 136. Alternatively, the service provider server 120 can generate and send an invoice (not shown) to the customer server 136 for the uncovered charges followed by funds transfer (not shown) to the service supplier to a financial institution associated therewith. Fund transfer is typically effected by transmitting wire transfer or other instructions to a financial institution having an account associated with the customer to transfer funds from the account to an account associated with the service provider. The service provider database 124 is updated to close out the work orders and indicate payment status of the invoices.

Regardless of the existence or nonexistence of warranty coverage, the service provider server 120 sends a product shipment notice 1008 to the customer server 136 indicating that the inventory items have been shipped. The shipment notice provides shipping information, as noted above.

The service provider server 120 sends to the servicing entity server 128 a servicing fee(s) invoice 1012 for the covered charges.

The servicing entity server 128 receives the invoice 1012, updates the servicing entity database 132, effects a transfer 1016 of funds to the service provider or a financial institution associated with the service provider. Fund transfer is typically effected by transmitting wire transfer or other instructions to a financial institution having an account associated with the servicing entity to transfer funds from the account to an account associated with the service provider. The servicing entity server 128 can send a payment notification to the service provider server 120. The servicing entity and service provider databases 132 and 124 are updated to reflect payment as noted above.

New inventory items may need to be shipped by the original supplier to the service provider. In that event, the service provider database 124 is updated to reflect the new inventory levels, and a product shipment notification 1020 is sent by the original supplier server 104 to the service provider server 120 providing shipping details noted above.

When the new inventory items are indicated by the service provider inventory management module 208, the service provider server 120 sends a product receipt 1024 to the servicing entity server 128. Upon receipt, the servicing entity server 128 updates the servicing entity database 132 to reflect the new inventory levels. It further generates and sends to the original supplier server 104 a warranty invoice 1028 indicating a payment amount to be paid into the warranty reserve to cover the new inventory items.

In response, the original supplier server 104 receives the invoice 1012, updates the original supplier database 108, effects a transfer 1036 of funds to the servicing entity or a financial institution associated with the servicing entity. Fund transfer is typically effected by transmitting wire transfer or other instructions to a financial institution having an account associated with the original supplier to transfer funds from the account to an account associated with the servicing entity. The original supplier server 104 can send a payment notification to the servicing entity server 128. The servicing entity and original supplier databases 132 and 108 are updated to reflect payment as noted above.

In some applications, the original supplier retains the right to repurchase the inventory items. This can be done by the original supplier server 104 generating and sending a repurchase notification 1040 to the servicing entity server 128, which can be acknowledged by the servicing entity server 128. In response, the servicing entity server 128 generates and sends the repurchase notification or a modified repurchase notification 1044 to the service provider server 120. To consummate the repurchase, the original supplier server 104 effects fund(s) transfer 1048 to the servicing entity or a financial institution associated therewith. Fund transfer is typically effected by transmitting wire transfer or other instructions to a financial institution having an account associated with the original supplier to transfer funds from the account to an account associated with the servicing entity. The original supplier server 104 can send a payment notification to the servicing entity server 128. The servicing entity and original supplier databases 132 and 108 are updated to reflect inventory repurchase and payment as noted above.

The service provider server 120 can be notified (not shown) by the servicing entity server 128 of payment being received, and the service provider ships the inventory items to the original supplier. An inventory shipment notice 1052 containing the information noted above can be generated and sent by the service provider server 120 to the original supplier server 104. The servicing entity server 128 can also transfer the reserve 1056 to the original supplier server 104 or a financial institution associated therewith. In the latter case, the servicing entity server 128 sends a transfer notification (not shown) to the original supplier server 104. The servicing entity and original supplier databases 132 and 108 are updated to reflect transfer of the warranty reserve from the servicing entity, or a financial institution associated therewith, to the original supplier, or a financial institution associated therewith.

With reference to FIG. 1, the inventory management system 100 can include, at any of the service provider server 120, original supplier server 104, financing entity server 112, and/or servicing entity server 128 and/or at a separate node, a microprocessor executable inventory pricing module 148 and financing module 150. The inventory pricing module 148 can determine unitized pricing for inventory. This is particularly beneficial for the system of FIGS. 8, 9A, and 9B where shorter term financing is employed and the financing costs vary. In other words, the inventory unit price fluctuates in response to the fluctuating cost of financing. The inventory financing module 150 can determine, based on market conditions and predetermined rules, when debt pricing is conducive to refinancing. This is particularly beneficial for the system of FIGS. 3-7, which uses a longer term loan and finances periodically the.

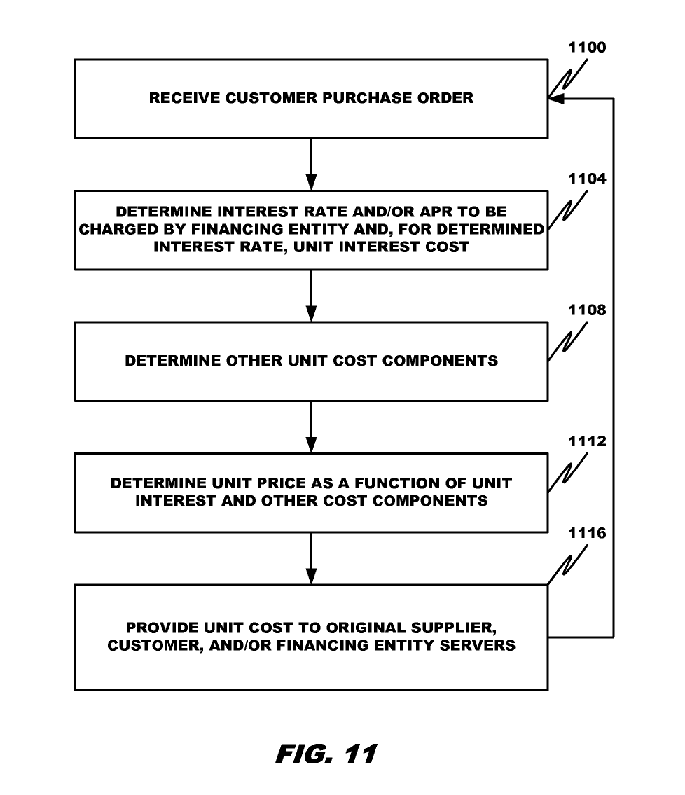

The operation of the inventory financing module 150 will now be discussed with reference to FIG. 11.

In step 1100, the inventory pricing module 148 is informed of receipt of a customer purchase order by the servicing entity server or service provider server.

In step 1104, the inventory pricing module 148 determines from the one or more of the service provider server 120 (and database 124) and servicing entity server 128 (and database 132) and/or the financing entity server 112 (and database 116) the interest rate and/or annual percentage rate (“APR”) to be charged by the financing entity for the proposed inventory sale and, for the determined interest rate, the unit interest cost (or the portion of the financing charge allocable to each item of inventory to be sold as part of the purchase order). As will be appreciated, the APR factors in fees, including points and origination fees, while the interest rate is just the basic interest charged.

In step 1108, the inventory pricing module 148 determines from the service provider server 120 (and database 124), original supplier server 104 (and database 108), and/or the servicing entity server 128 (and database 132) the other inventory unit cost components. The other unit cost components, for example, can include one or more of inventory book value, inventory market value or sales price, allocable management fees charged to the servicing entity by a provider of outsourced financial and legal administrative services controlling and/or managing the servicing entity, the allocable service fees charged to the servicing entity by the service provider, and the allocable financing charges of the financing entity. The allocation of the charges to units of inventory can be done on any suitable basis. Where different types of inventory items are involved, the allocation among inventory types can first be performed based on relative values of the inventory types, followed by allocation of the allocable share to the number of units in each inventory type.

In step 1112, the inventory pricing module 148 determines, based on the various cost components, the unit price for the inventory items. The unit price fluctuates largely in response to the financing charges. Thus, the unit price charged at a first time typically is different from the unit price for the same inventory item charged at a second time to the same or a different customer.

In step 1116, the inventory pricing module 148 provides the unit cost to the original supplier server, customer server, and/or financing entity server as a term of the inventory sale.

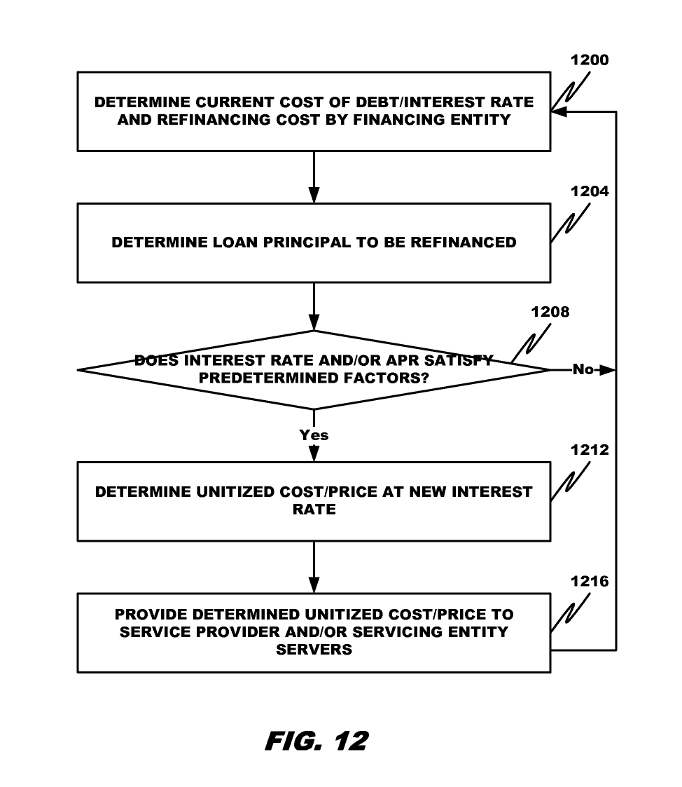

The operation of the inventory financing module 150 will now be discussed with reference to FIG. 12.

The inventory financing module 150, in step 1200, determines, via one or more internet search engines, a current cost of debt and/or interest rate and/or annual percentage rate (“APR”) and/or refinancing cost by one or more selected financial entities. As will be appreciated, the APR factors in fees, including points and origination fees, while the interest rate is just the basic interest charged. The information can be obtained from Web sites from financial entities and/or financial entity servers, such as via email. The interest rate and/or annual percentage rate is typically a prime rate or other rate applicable to the proposed inventory refinancing. A minimum or maximum loan term is typically associated with each interest rate. The interest rate can be fixed or floating, depending on the application. The stimulus for executing this step can be a clock setting, an administrator request, and the like. Additionally, the existing financing terms, rates, loan term, and other conditions are obtained from one or more of the service provider server, servicing entity server, and/or financing entity server, which access the respective database for the information.

The inventory financing module 150, in step 1204, determines the amount of loan principal to be refinanced. This information can be obtained from the any one of the service provider server, servicing entity server, and/or financing entity server, which access the respective database for the information.

In decision diamond 1208, the inventory financing module 150 determines whether one or more of the currently offered interest rates and/or refinancing costs satisfy one or more predetermined factors. The predetermined factors can be a maximum interest rate and/or APR and/or refinancing cost selected by an administrator. A maximum loan term, points, loan origination fees, balloon payment amount and timing, and/or total amount owed (which includes the original loan amount or amount borrowed plus interest and fees) can be a predetermined factor. In another configuration, the predetermined factors can be a percent or absolute reduction in interest rate and/or loan payments. This requires a comparison of each currently offered interest rate and/or APR from step 1200 to the existing or current contracted interest rate and/or APR. The loan principal to be refinanced can be used to determine the monthly payment.

When the interest rate and/or APR and/or other financing term of the potential refinancing products fail to satisfy one or more of the predetermined factors, the inventory refinancing module 150 returns to and repeats step 1200.

When one or more of the potential refinancing products satisfy all of the predetermined factors, the inventory financing module 150 proceeds to step 1212 and determines the unitized cost and/or price of the inventory for each of the financing products.

In step 1216, the inventory financing module 150 provides the various unitized costs and/or prices to the service provider and/or servicing entity servers. As part of step 1216, the inventory refinancing module 150 can compare the various unitized costs and/or prices to one another and/or to the current unitized cost and/or price of the finance product currently used to finance the inventory to illustrate the relative attractiveness of the new and/or existing finance product. A recommendation to refinance or not refinance can be provided by the inventory financing module 150 to the service provider and/or servicing entity servers.

If one or more of the potential finance products is of interest, the inventory financing module 150 can initiate contact with the corresponding financing entity and request more information and/or a customer representative to contact a designated administrator.

The exemplary systems and methods of this disclosure have been described in relation to a networked architecture. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, one or more of the messages transmitted over the network 140 is initiated by a human. For example, a human operator can scan a document and send the document, as an email attachment or fax, via one or servers.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. In a system comprising one or more servers receiving a customer purchase order for one or more items in inventory and one or more databases associated with an original supplier, service provider, and servicing entity, the one or more databases comprising data indicating that the one or more inventory items was supplied by the original supplier, is currently in the possession of the service provider, and is currently owned by the servicing entity, the one or more inventory items having previously been sold by the original supplier to the servicing entity and the one or more servers comprising service provider, servicing entity and original supplier servers, a method comprising:
sending, by the one or more servers, at least one of (a) a product shipment notification indicating that the one or more inventory items have been shipped by the service provider to the customer and (b) an invoice to a server of the customer for the one or more inventory items; and
performing one or more of the following steps:
(A) sending, by at least one of the service provider server and servicing entity server, an inventory report to the original supplier server, the inventory report comprising information regarding on-hand inventory in the possession of the service provider; and
(B) sending, by at least one of the service provider server and servicing entity server, the inventory report to a server associated with a financing entity, the financing entity having financed at least part of a purchase price of the inventory when purchased by the servicing entity from the original supplier.

2. The method of claim 1, wherein the customer purchase order is received by a server of the original supplier, wherein the service provider server receives a request from the original supplier server to ship the one or more inventory items to the customer, wherein the invoice for the one or more inventory items is sent, by the original supplier server to the customer server, wherein the customer pays the original supplier for the inventory items, wherein the one or more servers sends a servicing entity invoice to the original supplier server, and wherein the original supplier, in turn, pays the servicing entity for the one or more inventory items.

3. The method of claim 1, wherein step (A) is performed.

4. The method of claim 3, wherein the original supplier determines, based on the inventory report, whether one or more customer inventory requirements are satisfied and, when the one or more customer inventory requirements are unsatisfied or are in danger of being unsatisfied, the original supplier causes the servicing entity to send, via the servicing entity server, a purchase order to the original supplier server for more inventory items.

5. The method of claim 1, wherein step (B) is performed.

6. The method of claim 5, wherein the financing entity determines a loan payment based on the inventory report.

7. The method of claim 1, wherein the service provider does not control the servicing entity, the servicing entity does not control the service provider, and the servicing entity and service provider are not under common control.

8. The method of claim 8, wherein the service provider does not control the servicing entity and wherein the one or more inventory items are located physically in a warehouse owned by the service provider.

9. The method of claim 1, further comprising:
receiving, by the servicing entity server and from the service provider server, an invoice for inventory warehousing, management, fulfillment, inventory financial management, and/or distribution services with respect to the one or more inventory items; and
in response to receipt of the invoice, transmitting, by the servicing entity server, instructions to transfer funds from an account associated with the servicing entity to an account associated with the service provider.

10. The method of claim 1, wherein the one or more databases comprise data indicating that a warranty reserve for the one or more inventory items was transferred by the original supplier to the servicing entity, wherein warranty claims are serviced by the service provider, wherein the service provider server sends invoices for warranty servicing charges to the servicing entity server, and wherein the servicing entity server effects wire transfer of funds to an account associated with the service provider.

11. The method of claim 10, wherein, when new inventory items are provided by the original supplier to the servicing entity, the original supplier server effects wire transfer of funds to the servicing entity to cover any warranty claims on the new inventory items.

12. In a system comprising one or more servers receiving a customer purchase order for one or more items in inventory and one or more databases associated with an original supplier, service provider, and servicing entity, the one or more databases comprising data indicating that the one or more inventory items was supplied by the original supplier, is currently in the possession of the service provider, and is currently owned by the servicing entity, the one or more inventory items having previously been sold by the original supplier to the servicing entity and the one or more servers comprising service provider, servicing entity and original supplier servers, at least one of the service provider and servicing entity servers comprising:
a microprocessor executable purchasing module operable to send at least one of (a) a product shipment notification indicating that the one or more inventory items have been shipped by the service provider to the customer and (b) an invoice to a server of the customer for the one or more inventory items; and
at least one of:
a microprocessor executable inventory management module operable to send an inventory report to the original supplier server, the inventory report comprising information regarding on-hand inventory in the possession of the service provider; and
a microprocessor executable loan payment module operable to send the inventory report to a server associated with a financing entity, the financing entity having financed at least part of a purchase price of the inventory when purchased by the servicing entity from the original supplier.

13. The system of claim 12, wherein the customer purchase order is received by a server of the original supplier, wherein the service provider server receives a request from the original supplier server to ship the one or more inventory items to the customer, wherein the invoice for the one or more inventory items is sent, by the original supplier server to the customer server, wherein the customer pays the original supplier for the inventory items, wherein the one or more servers sends a servicing entity invoice to the original supplier server, and wherein the original supplier, in turn, pays the servicing entity for the one or more inventory items.

14. The system of claim 12, comprising a microprocessor executable inventory management module operable to send an inventory report to the original supplier server, the inventory report comprising information regarding on-hand inventory in the possession of the service provider.

15. The system of claim 14, wherein the original supplier determines, based on the inventory report, whether one or more customer inventory requirements are satisfied and, when the one or more customer inventory requirements are unsatisfied or are in danger of being unsatisfied, the original supplier causes the servicing entity to send, via the servicing entity server, a purchase order to the original supplier server for more inventory items.

16. The system of claim 12, comprising the microprocessor executable loan payment module.

17. The system of claim 16, wherein the financing entity determines a loan payment based on the inventory report.

18. The system of claim 12, wherein the service provider does not control the servicing entity, the servicing entity does not control the service provider, and the servicing entity and service provider are not under common control.

19. The system of claim 18, wherein the service provider does not control the servicing entity and wherein the one or more inventory items are located physically in a warehouse owned by the service provider.

20. The system of claim 14, wherein the inventory management module generates and sends an invoice for inventory warehousing, management, fulfillment, inventory financial management, and/or distribution services with respect to the one or more inventory items, wherein the servicing entity server receives, from the service provider server, the invoice for inventory warehousing, management, fulfillment, inventory financial management, and/or distribution services with respect to the one or more inventory items and wherein, in response to receipt of the invoice, the servicing entity server transmits instructions to transfer funds from an account associated with the servicing entity to an account associated with the service provider.

21. The system of claim 12, wherein the one or more databases comprise data indicating that a warranty reserve for the one or more inventory items was transferred by the original supplier to the servicing entity, wherein warranty claims are serviced by the service provider, wherein the service provider server sends invoices for warranty servicing charges to the servicing entity server, and wherein the servicing entity server effects wire transfer of funds to an account associated with the service provider.

22. The system of claim 21, wherein, when new inventory items are provided by the original supplier to the servicing entity, the original supplier server effects wire transfer of funds to the servicing entity to cover any warranty claims on the new inventory items.

23. In a system comprising a microprocessor executable service provider inventory management module and a service provider server including and/or in communication with the service provider inventory management module, the service provider receiving a customer purchase order for one or more items in inventory, and a service provider database comprising data indicating that the one or more inventory items was supplied by an original supplier, is currently in the possession of the service provider, and is currently owned by a servicing entity, the one or more inventory items having previously been sold by the original supplier to the servicing entity, a tangible and non-transient computer readable medium comprising microprocessor executable instructions for the inventory management module that, when executed by a microprocessor, perform operations, comprising:
send at least one of (a) a product shipment notification indicating that the one or more inventory items have been shipped by the service provider to the customer and (b) an invoice to a server of the customer for the one or more inventory items; and
at least one of the following:
(A) send, by the service provider server, an inventory report to an original supplier server of the original supplier, the inventory report comprising information regarding on-hand inventory in the possession of the service provider; and
(B) send, by the service provider server, the inventory report to a server associated with a financing entity, the financing entity having financed at least part of a purchase price of the inventory when purchased by the servicing entity from the original supplier.

24. The computer readable medium of claim 23, wherein the customer purchase order is received by a server of the original supplier, wherein the service provider server receives a request from the original supplier server to ship the one or more inventory items to the customer, wherein the invoice for the one or more inventory items is sent, by the original supplier server to the customer server, wherein the customer pays the original supplier for the inventory items, wherein the one or more servers sends a servicing entity invoice to the original supplier server, and wherein the original supplier, in turn, pays the servicing entity for the one or more inventory items.

25. The computer readable medium of claim 23, wherein operation (A) is performed.

26. The computer readable medium of claim 25, wherein the original supplier determines, based on the inventory report, whether one or more customer inventory requirements are satisfied and, when the one or more customer inventory requirements are unsatisfied or are in danger of being unsatisfied, the original supplier causes the servicing entity to send, via the servicing entity server, a purchase order to the original supplier server for more inventory items.

27. The computer readable medium of claim 23, wherein operation (B) is performed.

28. The computer readable medium of claim 27, wherein the financing entity determines a loan payment based on the inventory report.

29. The computer readable medium of claim 23, wherein the service provider does not control the servicing entity, the servicing entity does not control the service provider, and the servicing entity and service provider are not under common control.

30. The computer readable medium of claim 29, wherein the service provider does not control the servicing entity and wherein the one or more inventory items are located physically in a warehouse owned by the service provider.

31. The computer readable medium of claim 23, further comprising the operations:
receive an invoice for inventory warehousing, management, fulfillment, inventory financial management, and/or distribution services with respect to the one or more inventory items; and
in response to receipt of the invoice, transmit instructions to transfer funds from an account associated with the servicing entity to an account associated with the service provider.

32. The computer readable medium of claim 23, wherein the service provider database comprises data indicating that a warranty reserve for the one or more inventory items was transferred by the original supplier to the servicing entity, wherein warranty claims are serviced by the service provider, wherein the service provider server sends invoices for warranty servicing charges to the servicing entity server, and wherein the servicing entity server effects wire transfer of funds to an account associated with the service provider.

33. The computer readable medium of claim 32, wherein, when new inventory items are provided by the original supplier to the servicing entity, the original supplier server effects wire transfer of funds to the servicing entity to cover any warranty claims on the new inventory items.
